(19) United States
(12) Patent Application Publication
(10) Pub. No.: US 2026/0349715 A1
(43) Pub. Date: Nov. 5, 2026

(54) ARTIFICIAL INTELLIGENCE-BASED MULTI-AGENT FRAMEWORK

(71) Applicant: PAYPAL, INC., San Jose, CA (US)

(72) Inventors: Sathish Rama, Wilmington, DE (US); Venkata Ramana Rao Nallajarla, Hockessin, DE (US); Xuyao Hao, San Jose, CA (US); Fangbo Tu, San Francisco, CA (US); Suraj Arulmozhi, Chennai (IN); Cheng Zhu, San Jose, CA (US)

(21) Appl. No.: 19/197,547

(22) Filed: May 2, 2025

(51) Int. Cl. G06F 8/73; G06F 8/35

(52) U.S. Cl. CPC G06F 8/73; G06F 8/35

(57) ABSTRACT

Methods and systems are presented for providing an artificial intelligence (AI)-based framework for developing computer software applications. Under the framework, different artificial intelligence (AI) agents are configured and trained specifically to perform different tasks associated with developing a computer software application. The different AI agents communicate with each other to coordinate the performance of different tasks associated with developing the software application. When performing a task, each AI agent uses a knowledge graph that represents documents stored in a document repository to select a subset of the documents that are relevant to the task. The AI agent then uses content from the selected documents for developing a portion of the computer software application.

### BACKGROUND

The present specification generally relates to artificial intelligence frameworks, and more specifically, to an artificial intelligence-based multi-agent framework that facilitates computer software development according to various embodiments of the disclosure.

### Related Art

Computer software development is a complex and challenging task that requires subject matter experts (e.g., specialized computer software programmers, etc.) to generate and edit computer code, test and debug the computer code, and build and package a software application based on the tested computer code. Various tools have been provided in the past to enhance the efficiency of developing computer software applications. For example, integrated development environments (IDEs), have been used to assist the computer software programmers in generating software applications, such as by providing code suggestions in the code editing interface based on context of existing code, visually differentiating different elements of the code, such as keywords, variables, etc., in the code editing interface, providing version controls, providing visual aid for debugging the code, etc.

While these tools have improved the efficiency of the computer software programmers in developing computer applications, substantial effort is still required by the computer software programmers, such as writing the majority of the code, designing a structure of the programming code, testing and debugging, etc. Thus, there is a need for an advanced framework that can drastically improve the efficiency in developing software applications without relying on subject matter experts.

### BRIEF DESCRIPTION OF THE FIGURES

FIG. 1 is a block diagram illustrating an electronic transaction system according to an embodiment of the present disclosure;

FIG. 2 is a block diagram illustrating a conversation module according to an embodiment of the present disclosure;

FIG. 3 illustrates an example data flow for processing a complex task according to an embodiment of the present disclosure;

FIG. 4 is a block diagram illustrating a retrieval-augmented generation (RAG) module according to an embodiment of the present disclosure;

FIG. 5 is a flowchart showing a process of generating a knowledge graph according to an embodiment of the present disclosure;

FIG. 6 is a flowchart showing a process of an artificial intelligence (AI) agent using the knowledge graph to process a prompt according to an embodiment of the present disclosure;

FIG. 7 illustrates an example neural network that can be used to implement a machine learning model according to an embodiment of the present disclosure; and

FIG. 8 is a block diagram of a system for implementing a device according to an embodiment of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure describes methods and systems for providing an artificial intelligence-based framework for developing computer software applications. Under the framework, different artificial intelligence (AI) agents may be configured and trained specifically to perform different tasks associated with developing a computer software application (e.g., code generation, interfacing with data sources, code testing, detecting and solving bugs, errors, and failure points, etc.). The different AI agents may also be configured to communicate with each other (e.g., assigning jobs to another AI agent, receiving jobs from another AI agent, providing outputs to other AI agents, etc.) in order to coordinate the performance of different tasks associated with developing the software application.

As used herein, an AI agent may be implemented as a generative AI system that can include small language models (SLMs), large language models (LLMs), and the like, which are configured to understand and generate natural languages and/or programming languages. An LLM may adopt a transformer architecture that often entails a significant number of parameters and computational complexity. For example, a Generative Pre-trained Transformer (GPT) 3 has 175 billion parameters, and a Text-to-Text Transfer Transformer (T5) has around 11 billion parameters. A SLM, on the other hand, my include a smaller number of parameters, such as a few million parameters. In addition, an LLM or a SLM may include a mixed software/hardware architecture, e.g., including an application-specific integrated circuit (ASIC) such as a Tensor Processing Unit (TPU).

The framework provides (or includes) different AI agents that are specialized in performing different tasks associated with developing software applications. For example, the AI agents within the framework may include a code agent that is configured and trained to generate and manage programming code. The AI agents may also include a data agent that is configured and trained to interface with data sources such as databases, data repositories, etc. and to handle data retrieval and manipulation tasks. The AI agents may also include a test agent configured and trained to generate test scenarios and test the software application or any portion of the software application under the test scenarios. The AI agents may also include an error agent configured and trained to diagnose issues (e.g., bugs) related to the software application and provide and/or implement fixes for the bugs, errors, and failure points. The AI agents may also include a build agent configured and trained to build a software package based on the programming code. The AI agents may also include a planning agent configured and trained to breakdown a task into different jobs and assign the jobs to different AI agents. The different AI agents may be stored in an agent repository, such that they can be they can be searched and called upon by other AI agents to perform tasks under the framework.

The inclusion of different specialized AI agents in the framework enables a task (e.g., a task submitted by a user) to be divided into multiple jobs that can be performed separately by the different AI agents, which further enhances the efficiency and speed of completing the task. In addition, specialized AI agents may be trained to perform better (e.g., producing outputs that are of higher quality or accuracy, etc.) in their respective tasks than a general AI agent, which enables an overall higher quality or accuracy of outputs than using general AI agents.

Each of the AI agents within the framework may also be associated with metadata that specifies a domain expertise (e.g., specific areas of knowledge and functionality, etc.), a knowledge base (e.g., the data sources on which the AI agent relies on for performing tasks, etc.), inter-agent communication protocols (e.g., methods and protocols for other agents to interact with this AI agent, etc.), and task handling capabilities (e.g., specific tasks that the AI agent can perform, such as code generation, error diagnosis, etc.). The AI agents and the metadata may be stored in an agent repository that is accessible by all of the AI agents. In some embodiments, the AI agents under the framework uses information from the metadata of other AI agents to identify, assign tasks to, and/or communicate with other AI agents, such that the AI agents may work together in a coordinated effort to process the requested task faster and more efficiently.

In some embodiments, AI agents may be dynamically added to or removed from the framework. For example, a computer system may provide an interface that enables a user of the framework to request adding a new AI agent to the repository or removing an existing AI agent from the repository. When the user requests to add a new AI agent to the repository, the user may specify the roles and capabilities of the AI agent. A system may generate metadata for the new AI agent based on the descriptions provided by the user. The user may also specify configurations (e.g., parameter values, etc.) for the AI agent, and training data for training the AI agent, such that the AI agent may be specialized in performing one or more specific tasks. For example, the framework enables users to provide custom AI agents by configuring and/or customizing instances of a generic AI agent. The user may configure an instance of the generic AI agent using one or more parameters and/or hyperparameters, and then train/fine-tune the generic AI agent using training data specifically related to a particular domain (e.g., generating programming code using a particular language, generating programming code according to a particular programming paradigm, etc.), which may be provided by the user. The configuring and training turn the instance of the generic AI agent into a custom AI agent that is specialized in performing a specific task. After configuring and training the AI agent, the computer system may add the AI agent to the repository.

In some embodiments, when a task is received (e.g., a user submitting a prompt via a chat client), the computer system uses an AI agent (e.g., the planning agent) to analyze the task. If the task is a complex task (e.g., a task that can be divided into multiple sub-tasks or jobs), the planning agent may also divide the task into multiple jobs and assign the jobs to different AI agents. In some embodiments, the planning agent searches through the AI agents in the repository, determines the roles and capabilities of each of the AI agents in the repository based on the metadata of the AI agents, and breaks down the task according to the roles and capabilities of the AI agents. For example, when the task is related to creating a software application for performing a particular set of functionalities in a continuous integration/continuous delivery manner using Python as the programming language, the planning agent may divide the task into multiple jobs according to the specialties (e.g., capabilities) of the AI agents available in the repository. In the example where the repository includes the code agent, the test agent, the error agent, and the build agent, the planning agent may determine that the code agent may handle the job of generating the programming code, that the test agent may handle the job of testing the programming code, that the error agent may handle identifying and fixing errors within the programming code, and that the build agent may handle building a software package based on the programming code. The planning agent may divide the task into subtasks (e.g., jobs) according to the different capabilities of the AI agents. The jobs may include a job of generating programming code that performs the particular set of functionalities, a job of generating test scenarios for testing the programming code, a job of analyzing errors based on the testing and modifying the programing code to correct the errors, and a job to build a software package based on the programming code.

The planning agent may generate a job description (e.g., in the form of a prompt) for each of the jobs, and assign the jobs to the corresponding AI agents that can handle the job. For example, the planning agent may provide the corresponding job description (e.g., in a form of a prompt) to each of the selected AI agents. In some embodiments, at least some of the jobs may be further divided into multiple sub-jobs by one or more AI agents. As such, an AI agent who is assigned to process a job may generate sub-jobs based on the job and assign the sub-jobs to other AI agents. For example, the code agent may divide the particular set of functionalities into different subsets of functionalities, and may assign each subset of functionalities to different instances of the code agent (or different code agents that are specialized in the corresponding functionalities, etc.) or another AI agent that is specialized in generated a particular type of programming code. In some embodiments, the code agent determines any dependencies in the generation of the different portions of the programming code corresponding to the different subsets of functionalities, and instructs the specialized code agents to generate their corresponding portions of the programming code in parallel (when no dependencies are detected) or in sequence (when one portion of the programming code depends on another portion of the programming code).

When a first AI agent has completed processing the job that was assigned to the first AI agent by a second AI agent, the first AI agent may generate an output, and may provide the output to the second AI agent. For example, when a specialized code agent has generated a portion of the programming code corresponding to one or more functionalities, the specialized code agent may provide the portion of the programming code to the code agent. The code agent may receive other portions of the programming code from different specialized code agents, and may assemble the programming code based on the portions received from the different specialized code agents. When all of the portions are assembled into the programming code, the code agent may provide the generated programming code to the planning agent.

The planning agent may then instruct the test agent to test the programming code under one or more test scenarios, and may instruct the error agent to identify and fix any errors discovered in the programming code through the testing process. After fixing all of the discovered errors, the planning agent may instruct the build agent to build the software package based on the programming code.

In order to assist the AI agents to perform the assigned tasks, each of the AI agents within the framework may include (or has access to) a retrieval-augmented generation (RAG) component configured to retrieve documents relevant to the assigned tasks, such that the AI agent may perform the assigned tasks (e.g., generating an output such as programming code, test cases, etc.) using knowledge derived from the content of the retrieved documents. In some embodiments, the framework provides a document repository that stores documents related to software application development (e.g., previously-generated programming code, articles such as white paper related to developing software applications, articles that describe methods to generate different test cases for specific types of software code, articles related to specific programming languages or software development paradigm, etc.). When an AI agent receives a task, the RAG component may search for documents from the document repository that are related to the task, and retrieve the related documents. The RAG component may provide the retrieved documents to the AI agent (e.g., including the documents within the prompt, etc.), such that the AI agent may consider and/or use the content of the documents for performing the task.

In some embodiments, the framework provides an enhanced data structure and techniques for use by the RAG components of the AI agents in searching and retrieving relevant documents for the AI agents. Instead of searching through the entire corpus of documents in the document repository to identify relevant documents that are related to a task, under the framework, one or more clusters of documents within a graph (also referred to as a “knowledge graph”) are identified as relevant to the task based on attributes associated with the clusters, and only documents within the one or more clusters are searched to retrieve the relevant documents. The knowledge graph is constructed using content of the documents in the document repository. The computer system may construct the knowledge graph by first extracting attributes associated with each document in the document repository.

In some embodiments, the attributes are determined for each document from the perspective of an AI agent (e.g., based on queries or prompts that can be provided to the AI agent), rather than solely from the content of the document itself. Categorizing documents based on query-based attributes from the perspective of an AI agent enables documents to be matched with tasks with a higher accuracy (e.g., relevancy) than categorizing documents solely based on the content of the documents.

In some embodiments, the attributes are generated through a combination of clustering techniques and prompt engineering. For example, the attributes may be related to the type(s) of action that an AI agent can perform or the type(s) of question that an AI agent can answer using the content of the document. The attributes may correspond to different attribute types, such as a task, a topic, and a subject. A task is defined as a type of action or question posed in a query (e.g., a prompt) to an AI agent (e.g., how do I get access to Jenkins”). For each document, the computer system may analyze the content of the document, and determine the type of action or question that the document can be used by an AI agent for performing a corresponding action or for generating a corresponding answer. Since a document may include content that can be used to answer different types of questions or used to perform different types of actions, the computer system may determine multiple task attributes for a document.

A topic, in one example, is defined as an overarching subject matter of a query that can be submitted to an AI agent. For each document, the computer system may analyze the content of the document, and determine the subject matter(s) of queries (or prompts) for which the document can be used in generating an output. If the document can be used to generate an output for a prompt “generate a software application in a continuous integration/continuous deployment (CI/CD) manner using the programming language Python,” the topics assigned to the document may include “CI/CD.” It is noted that Python is used as an example only, and other programming languages can be used instead.

A subject is defined as the specific object or component within a query to an AI agent. Using the examples illustrated above, if the document can be used by an AI agent to generate an output for a prompt “how do I access Jenkins,” the subjects assigned to the document may include “Jenkins.” If the document can also be used to generate an output for a prompt “generate a software application in a CI/CD manner using the programming language Python,” the subjects assigned to the document may include “Python.”

The computer system may generate nodes to represent the different documents. Each node may include information associated with the document (e.g., a document identifier, a network address for locating the document, the attributes determined for the document, etc.). The computer system may also connect the nodes based on the attributes determined for the documents. For example, the computer system may connect two nodes with an edge when the two documents represented by the two nodes share at least one or more attributes (e.g., one or more tasks, one or more topics, one or more subjects, etc.).

After generating the graph by connecting nodes that share one or more attributes, the computer system may determine clusters of nodes within the graph. For example, the computer system may determine a cluster exists when the connections among a subset of the nodes in the graph exceeds a threshold (e.g., a density threshold, a connection threshold, etc.). The computer system may also assign attributes to each of the clusters based on the attributes of the nodes and/or the documents represented by the nodes within the cluster. For example, the computer system may determine, for each cluster, attributes that are shared among the documents represented by the nodes within the cluster.

When a query (e.g., in the form of a prompt) is received from a device or from another AI agent, the RAG component of the AI agent may analyze the query, and determine attributes associated with the query. In some embodiments, the attributes determined for the query correspond to the same attribute types as the ones determined for the documents. For example, the RAG component may determine one or more tasks, one or more topics, and one or more subjects associated with the query. The RAG component may then access the graph associated with the documents, and identify one or more clusters from the graph that match the query based on the attributes determined for the query (e.g., a match may occur when one or more common attributes exist between the query and the cluster, etc.). The RAG component may then search through the documents represented by the nodes within the one or more clusters (e.g., using one or more indices, such as a keyword index, a vector index, etc.) to determine one or more documents relevant to the query, and provide the one or more documents to the AI agent (e.g., as part of the prompt). The AI agent may then perform an action and/or generate an output based on the prompt using the content of the one or more documents.

The techniques described herein provide substantial improvements to the accuracy and speed performance of the RAG components of the AI agents. First, using query-based attributes to describe the documents enables more accurate matching between prompts and relevant documents. Second, by clustering the knowledge graph and only searching the documents within the relevant clusters in the knowledge graph as part of the process for determining relevant documents for a query (instead of searching all of the documents), the speed performance of the RAG components is also improved.

In order to assist the AI agents (e.g., the code agent, etc.) to generate programming code, the computer system may store documents that include sample programming code (e.g., previously-generated programming code, etc.), which can be used by the AI agents as resources for generating new programming code. Unlike human languages, it is challenging to determine attributes (e.g., a task, a topic, a subject, etc.) of the programming code by analyzing lines of programming code, or even a portion of the programming code (e.g., a “for” loop, an “if-else” statement, etc.), in a vacuum, since the programming code instructs a machine to perform specific operations (e.g., performing calculations to variables, assigning values to variables, etc.), but does not provide any context of what those operations, collectively, accomplish. As such, in some embodiments, the computer system may use an AI agent to analyze documents that include programming code based on the programing code itself in addition to other context related to the programming code (e.g., comments associated with lines of programming code, technical documents or marketing materials associated with a software product that is implemented using the programming code, etc.). The AI agent may also produce commentary to the programming code that explains the function of each portion of the programming code relative to the overall functionality of the programming code (e.g., annotating that a portion of the programming code is responsible for calculating a value to be used by another computer module in the programming code, etc.). The AI agent may then derive attributes (e.g., one or more tasks, one or more topics such as a programming language used in the programming code, one or more subjects, etc.) for the programming code based on the context associated with the programming code, and incorporate the document within the graph (e.g., the knowledge graph) based on the attributes.

It has been contemplated that the framework as disclosed herein can be used for other applications in addition to developing software applications. For example, the framework can be used generally for performing different types of tasks, such as data analysis (e.g., where the planning agent may use different AI agents to perform different types of data ingestions and data analysis tasks, etc.), project management (e.g., wherein the planning agent may use different AI agents to perform tasks related to ingesting communication data to determine a status of a project, projecting a completion date based on a progress, managing personnel of a team, etc.), and other tasks. Since users may incorporate additional AI agents that are specialized in different tasks, which allows the planning agent to dynamically select AI agents to perform new tasks that have not been performed previously, the framework can be flexible to accommodate the performance of different tasks dynamically.

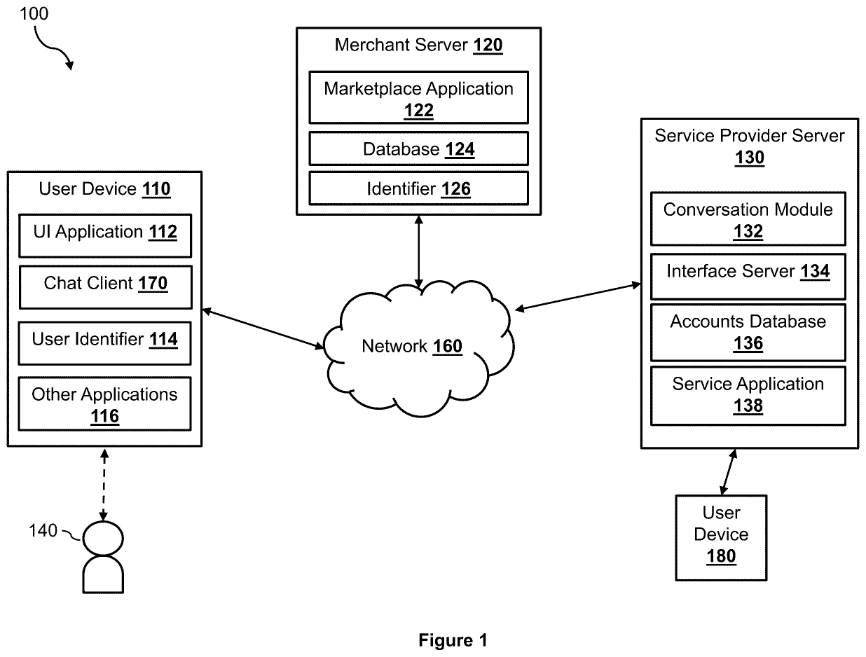

FIG. 1 illustrates an electronic transaction system 100, within which the AI-based framework system may be implemented according to one embodiment of the disclosure. The electronic transaction system 100 includes a service provider server 130, a merchant server 120, and user devices 110 and 180 that may be communicatively coupled with each other via a network 160. The network 160, in one embodiment, may be implemented as a single network or a combination of multiple networks. For example, in various embodiments, the network 160 may include the Internet and/or one or more intranets, landline networks, wireless networks, and/or other appropriate types of communication networks. In another example, the network 160 may comprise a wireless telecommunications network (e.g., cellular phone network) adapted to communicate with other communication networks, such as the Internet.

The user device 110, in one embodiment, may be utilized by a user 140 to interact with the merchant server 120 and/or the service provider server 130 over the network 160. For example, the user 140 may use the user device 110 to conduct an online purchase transaction with the merchant server 120 via websites hosted by, or mobile applications associated with, the merchant server 120. The user 140 may also log in to a user account to access account services or conduct electronic transactions (e.g., data access, account transfers or payments, etc.) with the service provider server 130. The user device 110, in various embodiments, may be implemented using any appropriate combination of hardware and/or software configured for wired and/or wireless communication over the network 160. In various implementations, the user device 110 may include at least one of a wireless cellular phone, wearable computing device, PC, laptop, etc.

The user device 110, in one embodiment, includes a user interface (UI) application 112 (e.g., a web browser, a mobile payment application, etc.), which may be utilized by the user 140 to interact with the merchant server 120 and/or the service provider server 130 over the network 160. In one implementation, the user interface application 112 includes a software program (e.g., a mobile application) that provides a graphical user interface (GUI) for the user 140 to interface and communicate with the service provider server 130 and/or the merchant server 120 via the network 160. In another implementation, the user interface application 112 includes a browser module that provides a network interface to browse information available over the network 160. For example, the user interface application 112 may be implemented, in part, as a web browser to view information available over the network 160. Thus, the user 140 may use the user interface application 112 to initiate electronic transactions with the merchant server 120 and/or the service provider server 130.

The user device 110 may also include a chat client 170 for facilitating online chat sessions with another chat client (e.g., a chat client of another device, such as the user device 180, a conversation module 132 of the service provider server 130, etc. The chat client 170 may be a software application executed on the user device 110 for providing a chat client interface for the user 140 and for exchanging (e.g., transmitting and receiving) messages with the other chat client (either via a peer-to-peer chat protocol or via a chat server). For example, during an online chat session with the conversation module 132, the chat client 170 may present a chat interface that enables the user 140 to input data (e.g., text data such as utterances, audio data, multi-media data, etc.) for transmitting to the conversation module 132. The chat interface of the chat client 170 may also present messages that are received from the conversation module 132. In some embodiments, the messages may be presented on the chat client interface in a chronological order according to a chat flow of the online chat session. The chat client 170 may be an embedded application that is embedded within another application, such as the UI application 112, or a software development application (e.g., within an integrated development environment, etc.). Alternatively, the chat client 170 may be a stand-alone chat client program (e.g., Slack®, WhatsApp®, Facebook® Messenger, iMessages®, etc.) that is not associated with any other software applications executed on the user device 110.

The user device 110, in various embodiments, may include other applications 116 as may be desired in one or more embodiments of the present disclosure to provide additional features available to the user 140. In one example, such other applications 116 may include security applications for implementing client-side security features, programmatic client applications for interfacing with appropriate application programming interfaces (APIs) over the network 160, and/or various other types of generally known programs and/or software applications. In still other examples, the other applications 116 may interface with the user interface application 112 and/or the chat client 170 for improved efficiency and convenience.

The user device 110, in one embodiment, may include at least one identifier 114, which may be implemented, for example, as operating system registry entries, cookies associated with the user interface application 112, identifiers associated with hardware of the user device 110 (e.g., a media control access (MAC) address), or various other appropriate identifiers. In various implementations, the identifier 114 may be passed with a user login request to the service provider server 130 via the network 160, and the identifier 114 may be used by the service provider server 130 to associate the user with a particular user account (e.g., and a particular profile).

In various implementations, the user 140 is able to input data and information into an input component (e.g., a keyboard) of the user device 110. For example, the user 140 may use the input component to interact with the UI application 112 (e.g., to conduct a transaction with the merchant server 120 and/or the service provider server 130, etc.). In another example, the user 140 may use the input component to interact with the chat client 170 (e.g., to request for information or for an action to be performed, such as requesting for a specific software application to be built, etc.). The user 140 may transmit questions/inquiries, and/or requests for performing certain tasks/transactions using the input component.

The user device 180 may include substantially the same hardware and/or software components as the user device 110, which may be used by a user to interact with the merchant server 120 and/or the service provider server 130.

The merchant server 120, in various embodiments, may be maintained by a business entity (or in some cases, by a partner of a business entity that processes transactions on behalf of the business entity). Examples of business entities include merchants, resource information providers, utility providers, online retailers, real estate management providers, social networking platforms, a cryptocurrency brokerage platform, etc., which offer various items for purchase and process payments for the purchases. The merchant server 120 may include a merchant database 124 for identifying available items or services, which may be made available to the user devices 110 and 180 for viewing and purchase by the respective users.

The merchant server 120, in one embodiment, may include a marketplace application 122, which may be configured to provide information over the network 160 to the user interface application 112 of the user device 110. In one embodiment, the marketplace application 122 may include a web server that hosts a merchant website for the merchant. For example, the user 140 of the user device 110 (or the user of the user device 180) may interact with the marketplace application 122 through the user interface application 112 over the network 160 to search and view various items or services available for purchase in the merchant database 124. The merchant server 120, in one embodiment, may include at least one merchant identifier 126, which may be included as part of the one or more items or services made available for purchase so that, e.g., particular items and/or transactions are associated with the particular merchants. In one implementation, the merchant identifier 126 may include one or more attributes and/or parameters related to the merchant, such as business and banking information. The merchant identifier 126 may include attributes related to the merchant server 120, such as identification information (e.g., a serial number, a location address, GPS coordinates, a network identification number, etc.).

While only one merchant server 120 is shown in FIG. 1, it has been contemplated that multiple merchant servers, each associated with a different merchant, may be connected to the user device 110 and the service provider server 130 via the network 160.

The service provider server 130, in one embodiment, may be maintained by a transaction processing entity or an online service provider, which may provide processing of electronic transactions between users (e.g., the user 140 and users of other user devices, etc.) and/or between users and one or more merchants. As such, the service provider server 130 may include a service application 138, which may be adapted to interact with the user device 110 and/or the merchant server 120 over the network 160 to facilitate the electronic transactions (e.g., electronic payment transactions, data access transactions, etc.) among users and merchants processed by the service provider server 130. In one example, the service provider server 130 may be provided by PayPal®, Inc., of San Jose, California, USA, and/or one or more service entities or a respective intermediary that may provide multiple point of sale devices at various locations to facilitate transaction routings between merchants and, for example, service entities.

In some embodiments, the service application 138 may include a payment processing application (not shown) for processing purchases and/or payments for electronic transactions between a user and a merchant or between any two entities (e.g., between two users, between two merchants, etc.). In one implementation, the payment processing application assists with resolving electronic transactions through validation, delivery, and settlement. As such, the payment processing application settles indebtedness between a user and a merchant, wherein accounts may be directly and/or automatically debited and/or credited of monetary funds in a manner as accepted by the banking industry.

The service provider server 130 may also include an interface server 134 that is configured to serve content (e.g., web content) to users and interact with users. For example, the interface server 134 may include a web server configured to serve web content in response to HTTP requests. In another example, the interface server 134 may include an application server configured to interact with a corresponding application (e.g., a service provider mobile application) installed on the user devices 110 and 180 via one or more protocols (e.g., RESTAPI, SOAP, etc.). As such, the interface server 134 may include pre-generated electronic content ready to be served to users. For example, the interface server 134 may store a log-in page and is configured to serve the log-in page to users for logging into user accounts of the users to access various services provided by the service provider server 130. The interface server 134 may also include other electronic pages associated with the different services (e.g., electronic transaction services, etc.) offered by the service provider server 130. As a result, a user (e.g., the user 140, the user of the user device 180, or a merchant associated with the merchant server 120, etc.) may access a user account associated with the user and access various services offered by the service provider server 130, by generating HTTP requests directed at the service provider server 130.

The service provider server 130, in one embodiment, may be configured to maintain one or more user accounts and merchant accounts in an accounts database 136, each of which may be associated with a profile and may include account information associated with one or more individual users (e.g., the user 140 associated with user device 110, the user associated with the user device 180, etc.) and merchants. For example, account information may include private financial information of users and merchants, such as one or more account numbers, passwords, credit card information, banking information, digital wallets used, or other types of financial information, transaction history, Internet Protocol (IP) addresses, device information associated with the user account. In certain embodiments, account information also includes user purchase profile information such as account funding options and payment options associated with the user, payment information, receipts, and other information collected in response to completed funding and/or payment transactions. It is noted that the accounts database 136 (and/or any other database used by the system disclosed herein may be implemented within the service provider server 130 or external to the service provider server 130 (e.g., implemented in a cloud, etc.).

In one implementation, a user may have identity attributes stored with the service provider server 130, and the user may have credentials to authenticate or verify identity with the service provider server 130. User attributes may include personal information, banking information and/or funding sources. In various aspects, the user attributes may be passed to the service provider server 130 as part of a login, search, selection, purchase, and/or payment request, and the user attributes may be utilized by the service provider server 130 to associate the user with one or more particular user accounts maintained by the service provider server 130 and used to determine the authenticity of a request from a user device.

In various embodiments, the service provider server 130 also includes a conversation module 132 that implements the AI-based framework as discussed herein. In some embodiments, the conversation module 132 may provide a user interface on devices (e.g., the user device 110, the user device 180, the merchant server 120, etc.) that enables users to submit utterances, such as questions and task requests related to different domains (e.g., building a software application, analyzing data, performing a transaction, etc.). As discussed herein, the conversation module 132 may communicate with chat clients (e.g., the chat client 170) that is embedded within different applications, such as within an integrated development environment, such that a user may submit to the conversation module 132 a request to generate programming code to be incorporated within a software application.

Based on the user inputs (e.g., utterances submitted by the user via a chat interface from voice or text), the conversation module 132 may generate content in response to the user inputs. For example, when the user 140 of the user device 110 submits an utterance “how do I connect to a Hadoop database using Python,” the conversation module 132 may generate content (e.g., a response, etc.) related to instructions and examples on how to connect to a Hadoop database using the programming language Python, and may transmit the generated content to the user via the chat interface as a response to the user inputs. In another example, when the user 140 of the user device 110 submits an utterance “I want to build a software application for processing dispute transactions,” the conversation module 132 may generate content (e.g., programming code, a software package, etc.) that is executable for processing transaction disputes.

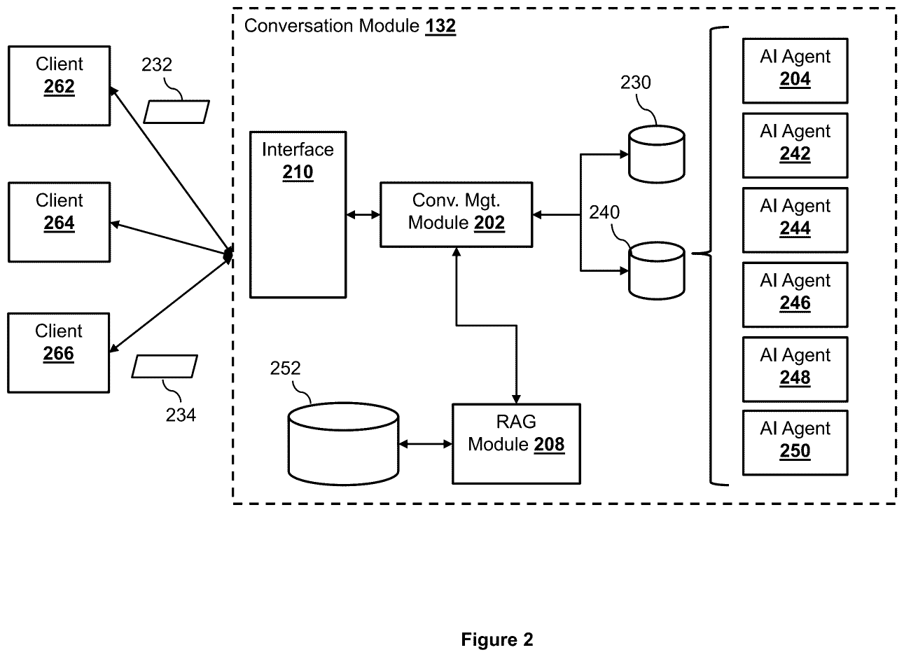

FIG. 2 illustrates a block diagram of the conversation module 132 according to an embodiment of the disclosure. The conversation module 132 includes a conversation management module 202, AI agents 204, 242, 244, 246, 248, and 250, a tool repository 230, a RAG module 208 having access to a document repository 252, and an interface 210 via which different clients, such as clients 262, 264, 266, etc. may communicate with the conversation module 132. Each of the clients 262, 264, and 266 may correspond to different types of applications within which a chat client (e.g., the chat client 170) may be embedded. Examples of the clients 262, 264, 266 may include a software module (e.g., a plug-in, etc.) embedded within an integrated development environment, a software module (e.g., an extension, a plug-in, etc.) embedded within a web browser, a third-party chat program (e.g., Slack®, Microsoft Team®, etc.), a command-line interface (e.g., a terminal, etc.) from a computer system, etc.

Information associated with one or more of the AI agents (e.g., the AI agents 204, 242, 244, 246, 248, and 250) may be stored in an agent repository 240 that is accessible by other components of the conversation module 132 (e.g., the conversation module 202, each of the AI agents, etc.). In some embodiments, one or more of the AI agents 204, 242, 244, 246, 248, and 250 may be stored in the agent repository 240. In some embodiments, one or more of the AI agents 204, 242, 244, 246, 248, and 250 may be stored and/or deployed in other computer systems, such as a cloud computing system. As such, the information stored in the agent repository 240 may include access information (e.g., a network address, etc.) for access the AI agents. Each of the AI agents 204, 242, 244, 246, 248, and 260 may be configured and trained to perform a specific job. For example, the AI agent 204 may correspond to a planning agent configured and trained to breakdown a task associated with a request submitted by a user via one of the clients 262, 264, and 266 into multiple sub-tasks according to various specialties of the AI agents available in the agent repository 240, and assign the sub-tasks to different AI agents. The AI agent 242 may correspond to a code agent configured and trained to generate and manage computer programming code, the AI agent, the AI agent 244 may correspond to a data agent configured and trained to interface with data sources such as databases, data repositories, etc. and to handle data retrieval and manipulation tasks, the AI agent 246 may correspond to a test agent configured and trained to generate test scenarios and test the software application or any portion of the software application under the test scenarios, the AI agent 248 may correspond to an error agent configured and trained to diagnose issues (e.g., bugs) related to the software application and provide and/or implement fixes for the bugs, errors, and failure points, and the AI agent 250 may correspond to a build agent configured and trained to build a software package based on the programming code.

Each of the AI agents 204, 242, 244, 246, 248, and 260 may use the tools included in the tool repository 230 for performing a task. The tools included in the tool repository 230 may include an application programming interface (API) connector tool for connecting to different computer systems and modules using one or more APIs, a database connector tool for connecting to various types of database systems, a formatter tools for formatting text, an email notifier tool for sending emails to various users (e.g., notifying that the task is complete, etc.), a query runner tool for executing database queries, a code runner tool for executing programming code, a data generator tool for generating data (e.g., training data, etc.), and other types of tools.

The AI agents may be generated by different parties, such as the entity (e.g., an organization, a team within the organization, etc.) that generated and/or managed the conversation module 132 or other users. For example, users of the clients 262, 264, and 266 may generate customized AI agents for performing additional tasks related to the software development process. When a user requests to generate a customized AI agent via the interface 210, the conversation management module 202 may generate (or instantiate) an instance of a generic AI agent. The conversation management module 202 may also configure (e.g., determine the parameters and hyperparameters, etc.) and train the instance of the generic AI agent according to the instructions provided by the user, which converts the instance of the generic AI agent into a customized AI agent. When the request specifies an AI agent that is configured to perform a specific task, the user may provide (or specify) training data that can be used to train the customized AI agent. As such, the conversation management module 202 may train the customized AI agent using the training data provided/specified by the user. The conversation management module 202 may then store information associated with the customized AI agent along with other AI agents in the agent repository 240. For example, a user may request to add and/or build an AI agent that is specialized in generating programming code in a specific programming language, generating programming code according to a specific software architecture, etc.

The information stored in the agent repository 240 may also include metadata associated with each of the AI agents, including a domain expertise (e.g., specific areas of knowledge and functionality, etc.), a knowledge base (e.g., the data sources on which the AI agent relies on for performing tasks, etc.), inter-agent communication protocols (e.g., methods and protocols for other agents to interact with this AI agent, etc.), and task handling capabilities (e.g., specific tasks that the AI agent can perform, such as code generation, error diagnosis, etc.). The metadata associated with the AI agents may be used by the conversation management module 202 and/or different AI agents to identify other AI agents for processing specific jobs and communicate with other AI agents.

The conversation module 132 may receive a query (e.g., a prompt) 232 from one of the clients 262, 264 or 266. The query 232 may be related to a task, such as a request to build a software application having a set of features (e.g., using a particular programming language, built under a particular computer software paradigm, configured to perform a set of functionalities, etc.). After receiving the query 232 via the interface 210, the conversation management module 202 may pass the query 232 to the AI agent 204. The AI agent 204 may correspond to the planning agent described herein, and may be configured to process the query 232 using one or more of the AI agents.

In some embodiments, the AI agent 204 may divide the task into multiple jobs that can be assigned to different AI agents (which may have functionalities that the AI agent 204 may not have) based on the information stored in the agent repository 240. For example, the AI agent 204 may analyze the metadata associated with each of the AI agents stored in the agent repository 240, and determine if the metadata of any AI agent can be utilized in assisting with performing the task (e.g., having metadata that matches with the task, etc.). Based on the metadata stored in the agent repository 240, the AI agent 204 may determine that the AI agent 242 (which may correspond to the code agent described herein), the AI agent 246 (which may correspond to the test agent described here), the AI agent 248 (which may correspond to the error agent), and the AI agent 250 (which may correspond to the build agent described herein) are relevant to the performance of the task of building the software application.

The AI agent 204 may then divide the task of building the software application into multiple jobs based on the metadata associated with the AI agents, and assign the jobs to the corresponding AI agents. For example, the AI agent 204 may divide the task of building the software application into multiple jobs related to the task, including a job of generating programming code, a job of generating test scenarios for testing the programming code and testing the programming code, a job of identifying errors in the programming code and fixing the errors, and a job of compiling and building a software package based on the programming code. The AI agent 204 may generate job descriptions for the jobs, and may assign the jobs to the corresponding AI agents based on the job description and the metadata associated with the AI agents. Based on the metadata stored in the agent repository 240, the AI agent 204 may select the AI agent 242 for process the job of generating the programming code for the task, the AI agent 246 for generating test scenarios and testing the programming code, the AI agent 248 for identifying defects/bugs within the programing code and fixing the defects/bugs, and the AI agent 250 for building a software package based on the programming code. The AI agent 204 may receive outputs produced by one or more of the AI agents 242, 246, 248, and 250, and may produce a final output 234 (e.g., the software package) for the user. The conversation module 132 may then provide the final output 234 to the client via the interface 210.

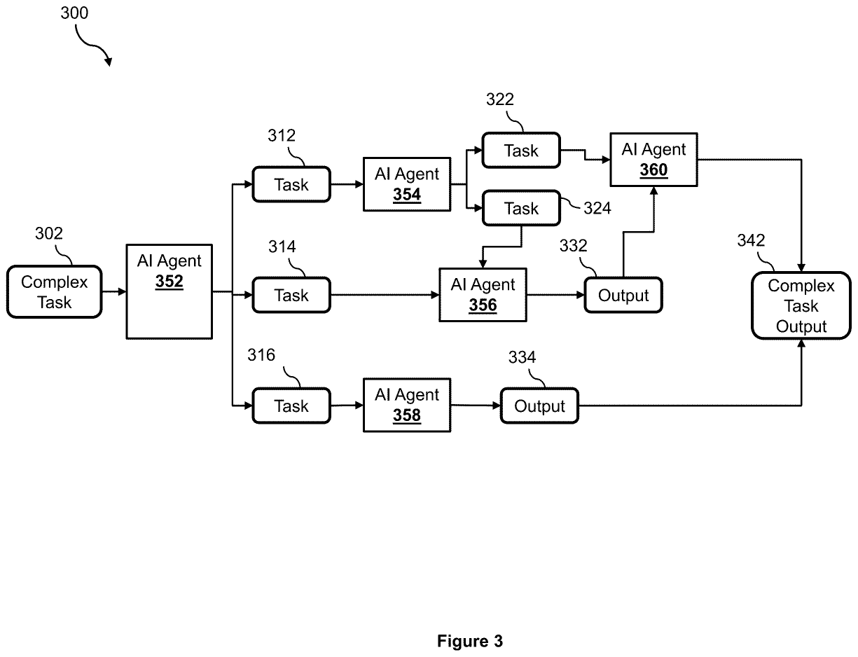

FIG. 3 illustrates an example data flow 300 for processing a task by the conversation module 132 according to various embodiments of the disclosure. As discussed herein, when an AI agent receives a task from a client, the AI agent may divide the task into multiple different jobs, and assign the jobs to different AI modules to process. In some embodiments, in order to enhance the efficiency of the AI agents in processing the different jobs, the AI agent may instruct certain jobs to be processed in parallel if the jobs do not depend on each other, and may instruct certain jobs to be processed in sequence if one job depends on the other job (e.g., one job requires an output from the processing of the other job, etc.).

In the data flow 300, an AI agent 352 may receive a task 302. The AI agent 352 may correspond to the planning agent as described herein (e.g., the AI agent 204 from FIG. 2). The task 302 may be considered a complex task because it can be broken down into multiple smaller tasks (or jobs) handled by different AI agents. The task 302 may be associated with building a software application. The AI agent 352 may divide the task 302 into tasks 312, 314, and 316. The task 312 may be associated with generating programming code for the software application, the task 314 may be associated with testing and debugging the programming code, and the task 316 may be associated with determining parameters for the software application (e.g., different thresholds for assessing a risk, etc.). The AI agent 352 may also generate job descriptions for the tasks 312, 314, and 316, and select AI agents to process the tasks 312, 314, and 316 based on matching the job descriptions with metadata associated with the different AI agents stored in a agent repository. In this example, based on the job descriptions and the metadata, the AI agent 352 may assign the task 312 to the AI agent 352, assign the task 314 to the AI agent 356, and assign the task 316 to the AI agent 358.

The AI agent 352 may also determine the dependencies among the tasks 312, 314, and 316. For example, the AI agent 352 may determine that the tasks 314 depends on the task 312 (e.g., processing of the task 314 requires an output from processing the task 312). As such, the AI agent 352 may instruct the AI agent 356 to wait for the output from the AI agent 354 before processing the task 314. The AI agent 352 may also determine that the task 316 is not dependent on either the task 312 or 314. As such, the AI agent 352 may instruct the AI agent 358 to start processing the task 316 immediately (e.g., in parallel with the AI agent 354 processing the task 312).

In some embodiments, one or more of the AI agents 354, 356, and 358 may further divide the corresponding task into even smaller tasks, and assign them to other AI agents. In this example, the AI agent 354 may determine that the task 312 may be further divided into tasks 322 and 324 (each may be associated with generated a different portion of the programming code). The AI agent 354 may then assign the task 322 to an AI agent 360 and assign the task 324 to the AI agent 356 based on the job descriptions of the tasks 322 and 324 and the metadata of the AI agents. The AI agent 354 may also determine dependencies between the tasks 322 and 324 such the AI agent 354 may instruct the AI agents 360 and 356 to process the tasks 322 and 324 in parallel or in sequence. In this example, the AI agent 354 may determine that the task 322 requires the output from processing the tasks 324 and 314. As such, the AI agent 354 may instruct the AI agent 360 to wait for an output from the AI agent 356 before processing the task 322. The AI agent 356 may process the task 324 and then the task 314 to generate an output 332. The output 332 may correspond to a portion of programming code for the software application. The AI agent 356 may provide the output 332 to the AI agent 360. The AI agent 360 may then process the task 322 (e.g., incorporating additional programing code into the software application).

The AI agent 358 may also process the task 316 to generate an output 334 (e.g., parameters for the software application). The output from the AI agent 360 (e.g., the programming code) may be combined with the output 334 (e.g., the parameters) to generate the task output 342 (e.g., a complete software application).

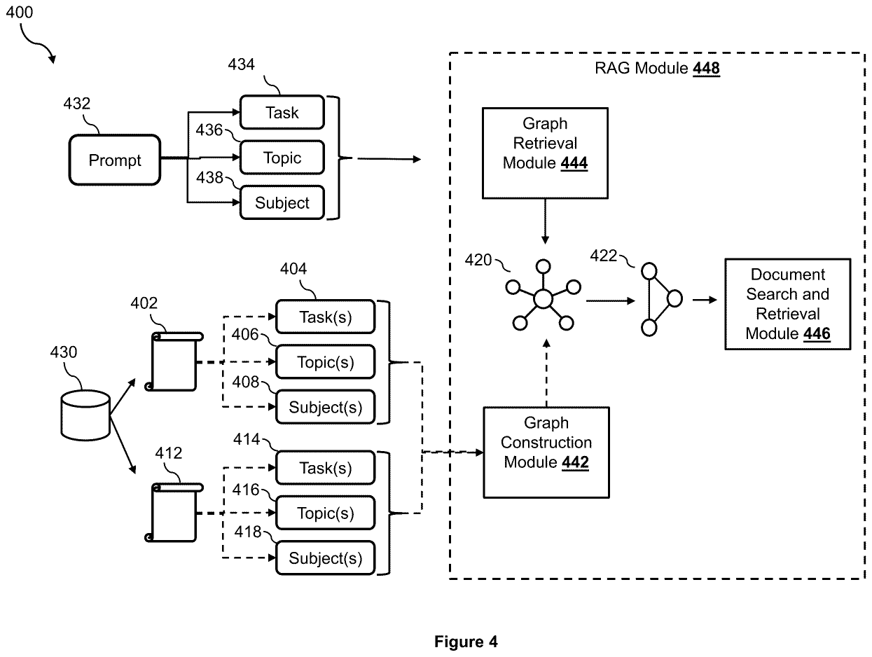

FIG. 4 illustrates a retrieval-augmented generation (RAG) module that can be utilized by one or more of the AI agents for retrieving relevant content in performing a task according to various embodiments of the disclosure. As shown, a RAG module 448 includes a graph retrieval module 444, a graph construction module 442, and a document search and retrieval module 446. In some embodiments, the RAG module 448 corresponds to the RAG module 208 in FIG. 2.

The RAG module 448 may be communicatively coupled to a document repository 430, which may correspond to the document repository 252 in FIG. 2. The document repository 430 may store documents that are related to the entity associated with the service provider server 130 and/or related to various tasks that are performed by the entity. For example, the documents may include documents related to software application development, such as previously-generated programming code, articles such as white paper related to developing software applications, articles that describe methods to generate different test cases for specific types of software code, articles related to specific programming languages or software development paradigm, etc. The document repository 430 may also include documents related to other tasks that can be performed by the conversation module 132 for the users, such as data analysis tasks, project management tasks, etc.

In some embodiments, the RAG module 448 provides an enhanced data structure and techniques for representing the documents within the document repository 430 and for retrieving the documents for performing different tasks by the different AI agents. For example, the RAG module 448 may use the graph construction module 442 to construct a graph (also referred to as a “knowledge graph”) for representing the documents stored in the document repository 430. To generate the graph, the graph construction module 442 may first determine attributes associated with each of the documents stored in the document repository 430.

In some embodiments, the attributes are determined for each document from the perspective of an AI agent (e.g., based on queries or prompts that can be provided to the AI agent), rather than solely from the content of the document itself. Categorizing documents based on query-based attributes from the perspective of an AI agent enables documents to be matched with tasks with a higher accuracy (e.g., relevancy) than categorizing documents solely based on the content of the documents.

For example, the attributes determined for a document may be related to the type(s) of action that an AI agent can perform or the type(s) of question that an AI agent can answer using the content of the document. The attributes may correspond to different attribute types, such as a task, a topic, and a subject. A task is defined as a type of action or question posed in a query (e.g., a prompt) to an AI agent (e.g., how do I get access to Jenkins”). For each document, the computer system may analyze the content of the document, and determine the type of action or question that the document can be used by an AI agent for performing a corresponding action or for generating a corresponding answer. Since a document may include content that can be used to answer different types of questions or used to perform different types of actions, the graph construction module 442 may determine multiple task attributes for a document.

A topic, in one example, is defined as an overarching subject matter of a query that can be submitted to an AI agent. For each document, the graph construction module 442 may analyze the content of the document, and determine the subject matter(s) of queries (or prompts) for which the document can be used in generating an output. If the document can be used to generate an output for a prompt “generate a software application in a continuous integration/continuous deployment (CI/CD) manner using the programming language Python,” the topics assigned to the document may include “CI/CD.”

A subject is defined as the specific object or component within a query that can be provided to an AI agent. Using the examples illustrated above, if the document can be used by an AI agent to generate an output for a prompt “how do I access Jenkins,” the subjects assigned to the document may include “Jenkins.” If the document can also be used to generate an output for a prompt “generate a software application in a CI/CD manner using the programming language Python,” the subjects assigned to the document may include “Python.”

As such, the graph construction module 442 may assign one or more task attributes, one or more topic attributes, and one or more subject attributes to each of the documents based on analyzing the content of the document. For example, the graph construction module 442 may assign, to a document 402, one or more task attributes 404, one or more topic attributes 406, and one or more subject attributes 408 based on the content included in the document 402. The graph construction module 442 may also assign, to a document 412, one or more task attributes 414, one or more topic attributes 416, and one or more subject attributes 418 based on the content included in the document 412.

In order to assist the AI agents (e.g., the code agent, etc.) to generate programming code, some of the documents that are stored in the document repository 430 may include sample programming code (e.g., previously-generated programming code, etc.), which can be used by the AI agents as resources for generating new programming code. Unlike human languages, it is challenging to determine attributes (e.g., a task, a topic, a subject, etc.) of the programming code by analyzing lines of programming code, or even a portion of the programming code (e.g., a “for” loop, an “if-else” statement, etc.), in a vacuum, since the programming code instructs a machine to perform specific operations (e.g., performing calculations to variables, assigning values to variables, etc.), but does not provide any context of what those operations, collectively, accomplish. As such, in some embodiments, the graph construction module 442 may use an AI agent to analyze documents that include programming code based on other context related to the programming code (e.g., comments associated with lines of programming code, technical documents or marketing materials associated with a software product that is implemented using the programming code, etc.). The AI agent may also produce commentary to the programming code that explains the function of each portion of the programming code relative to the overall functionality of the programming code (e.g., annotating that a portion of the programming code is responsible for calculating a value to be used by another computer module in the programming code, etc.). The AI agent may then derive attributes (e.g., one or more tasks, one or more topics, one or more subjects, etc.) for the programming code based on the context associated with the programming code.

After assigning various attributes to the documents, the graph construction module 442 may construct a graph 420 by generating nodes to represent the different documents stored in the document repository 430. Each node may include information associated with the document (e.g., a document identifier, a network address for locating the document, the attributes determined for the document, etc.). The graph construction module 442 may also connect the nodes based on the attributes determined for the documents. For example, the graph construction module 442 may connect two nodes with an edge when the two documents represented by the two nodes share at least one or more attributes (e.g., one or more tasks, one or more topics, one or more subjects, etc.).

The graph construction module 442 may then determine clusters of nodes within the graph 420 based on the connections (e.g., edges) among the nodes. For example, the graph construction module 442 may identify a cluster within a portion of the graph 420 when the connections among a subset of the nodes within the portion of the graph 420 exceeds a threshold (e.g., a density threshold, a connection threshold, etc.). Since the nodes within each cluster of the graph 420 represent documents that have common attributes, the graph construction module 442 may also assign attributes to each of the clusters based on the attributes of the nodes and/or the documents represented by the nodes within the cluster. For example, the graph construction module 442 may determine, for each cluster, attributes that are shared among a percentage of the documents (e.g., 100%, 90%, 70%, etc.) represented by the nodes within the cluster. In some embodiments, the graph construction module 442 may also generate one or more indices based on the documents included in each cluster. The one or more indices may include a keyword index, a semantic index, or any other types of indices. The one or more indices may be used by the document search and retrieval module 446 to search and retrieve documents within the graph 420 based on a prompt.

Using the graph 420, the RAG module 448 may be utilized by any one of the AI agents to retrieve relevant documents for the AI agent based on a prompt. For example, when a task request (e.g., in the form of a prompt 432) is received by the RAG module 448 from an AI agent, the RAG component may use the graph 420 to retrieve relevant documents that can assist the AI agent in performing the task associated with the prompt 432. In this regard, the RAG module 448 may analyze the prompt 432, and determine attributes associated with the prompt 432. In some embodiments, the attributes determined for the prompt 432 may correspond to the same attribute types as the ones determined for the documents stored in the document repository 430. For example, the RAG module 448 may determine one or more task attributes, one or more topic attributes, and one or more subject attributes associated with the prompt 432. The RAG module 448 may then use the graph retrieval module 444 to access the graph 420, and identify one or more clusters 422 from the graph 420 that match the prompt 432 based on the attributes determined for the prompt 432 (e.g., a match may occur when one or more common attributes exist between the prompt 432 and the clusters 422, etc.). The RAG module 448 may then use the document search and retrieval module 446 to search through the documents represented by the nodes within the one or more clusters 422 (e.g., using one or more indices, such as a keyword index, a vector index, etc.) to determine one or more documents that are relevant to the prompt 432, and provide the one or more documents to the AI agent (e.g., as part of the prompt). The AI agent may then perform an action and/or generate an output based on the prompt using the content of the one or more documents.

Using the techniques disclosed herein, the computer resource usages (e.g., computer processing power, computer memory, etc.) and time when retrieving documents from the document repository 430 may each be substantially reduced. It is because only a small portion of the documents associated with the identified cluster(s) (instead of the entire corpus of documents) within the document repository 430 is required to be searched for a prompt. This is especially beneficial to the conversation module 132 when the amount of documents stored in the document repository 430 is large and diverse (e.g., documents that can be used to perform multiple different types of tasks, etc.).

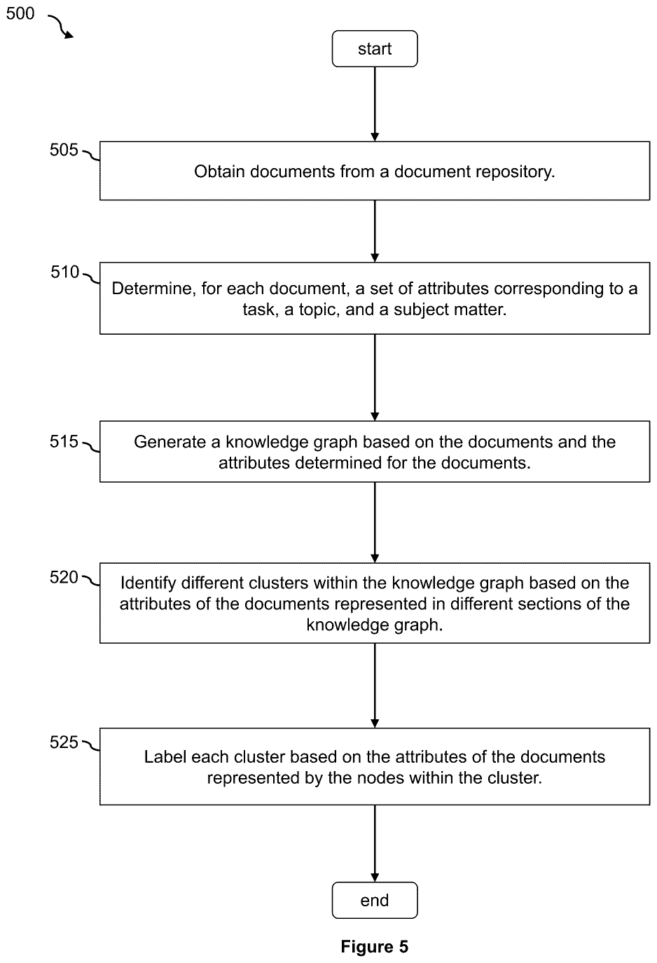

FIG. 5 illustrates a process 500 for generating a knowledge graph for documents stored in a document repository according to various embodiments of the disclosure. In some embodiments, at least a portion of the process 500 may be performed by the conversation module 132, although one or more steps may be performed by one or more of the components/devices/modules/systems described herein. The process 500 begins by obtaining (at step 505) documents from a document repository and determining (at step 510), for each document, a set of attributes corresponding to a task, a topic, and a subject matter. For example, the RAG module 448 may access the documents stored in the document repository 430. The RAG module 448 may use the graph construction module 442 to construct a graph (e.g., the graph 420) to represent the documents. The graph construction module 442 may first analyze the content of each document, and assign attributes to each document based on the content of the document. The attributes may include one or more task attributes, one or more topic attributes, and one or more subject attributes.

The graph construction module 442 then generates (at step 515) a knowledge graph based on the documents and the attributes determined for the documents. For example, the graph construction module 442 may generate a node to represent each document stored in the document repository 430. The node may include information that represents the document, such as an identifier that identifies the document, a network address associated with the document, attributes determined for the document, etc. The graph construction module 442 may then create the graph 420 by connecting nodes that share at least one or more attributes.

After generating the graph, the graph construction module 442 identifies (at step 520) different clusters within the knowledge graph based on the attributes of the documents represented in different sections of the knowledge graph. For example, the graph construction module 442 may identify a cluster within the graph 420 based on the connections (e.g., a connection density, etc.) among the nodes within a portion of the graph 420 (e.g., when the connection density within the portion of the graph 420 exceeds a threshold, etc.). The graph construction module 442 then labels (at step 525) each cluster based on the attributes of the documents represented by the nodes within the cluster. Since the documents represented by the nodes within each cluster share one or more attributes, the graph construction module 442 may extract the common attribute(s) from the nodes in each cluster, and label the cluster with the common attribute(s).

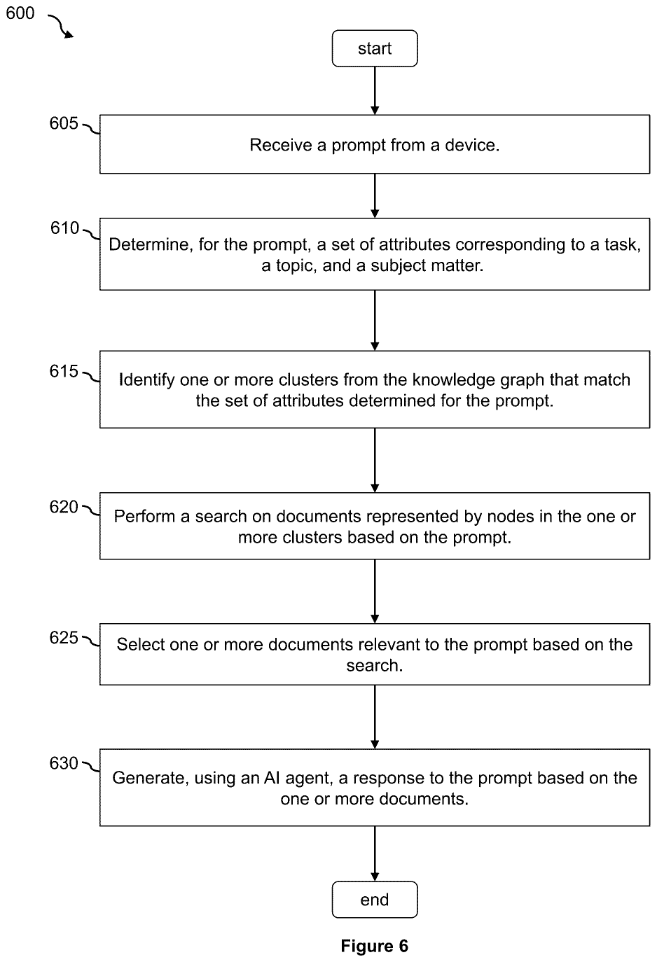

FIG. 6 illustrates a process 600 for processing a prompt according to various embodiments of the disclosure. In some embodiments, at least a portion of the process 600 may be performed by the conversation module 132, although one or more steps may be performed by one or more of the components/devices/modules/systems described herein. The process 600 begins by receiving (at step 605) a prompt from a device. For example, the prompt may be received by the conversation module 132 from one of the clients 262, 264, and 266. In another example, the prompt may be generated by one of the AI agents (e.g., the planning agent) and provided to another AI agent. The prompt may be used by the RAG module (e.g., the RAG module 208, the RAG module 448, etc.) to retrieve relevant documents before providing the prompt, along with the retrieved documents, to the AI agent.

Upon receiving the prompt, the RAG module determines (at step 610), for the prompt, a set of attributes corresponding to a task, a topic, and a subject matter. For example, the RAG module may analyze the content of the prompt, and assign one or more task attributes, one or more topic attributes, and one or more subject matter attributes to the prompt. The attributes of the prompt may be used by the RAG module to retrieve documents that are relevant to the prompt.

In this regard, the RAG module identifies (at step 615) one or more clusters from the knowledge graph that match the set of attributes determined for the prompt, performs (at step 620) a search on documents represented by nodes in the one or more clusters based on the prompt, and selects (at step 625) one or more documents that are relevant to the prompt based on the search. For example, the RAG module may compare the attributes determined for the prompt against attributes determined for each of the clusters in the graph 420. The RAG module may identify one or more clusters having attributes that match the attributes of the prompt (e.g., having at least one common attribute, etc.). After identifying the one or more clusters, the RAG module may search through only the documents represented by nodes within the one or more clusters. The RAG module may select one or more documents from the documents represented by the one or more clusters that are relevant to the prompt based on an index (e.g., a keyword index, a semantic index, etc.).

The RAG module may then modify the prompt by incorporating the selected documents into the prompt, and provide the modified prompt to the AI agent. The AI agent then generates (at step 630) a response to the prompt based on the one or more documents.

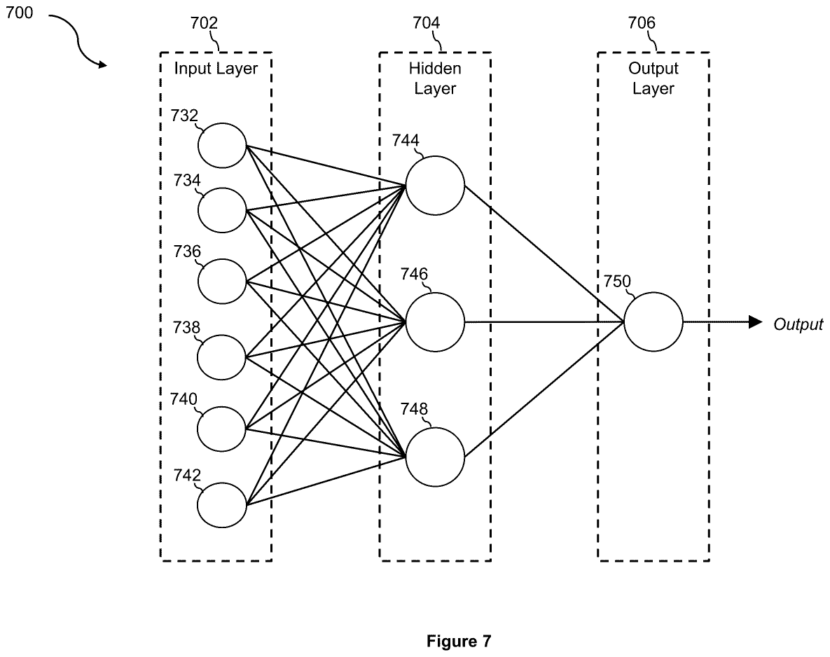

FIG. 7 illustrates an example artificial neural network 700 that may be used to implement a machine learning model, such as any one of the AI agents 204, 242, 244, 246, 248, and 250. As shown, the artificial neural network 700 includes three layers-an input layer 702, a hidden layer 704, and an output layer 706. Each of the layers 702, 704, and 706 may include one or more nodes (also referred to as “neurons”). For example, the input layer 702 includes nodes 732, 734, 736, 738, 740, and 742, the hidden layer 704 includes nodes 744, 746, and 748, and the output layer 706 includes a node 750. In this example, each node in a layer is connected to every node in an adjacent layer via edges and an adjustable weight is often associated with each edge. For example, the node 732 in the input layer 702 is connected to all of the nodes 744, 746, and 748 in the hidden layer 704. Similarly, the node 744 in the hidden layer is connected to all of the nodes 732, 734, 736, 738, 740, and 742 in the input layer 702 and the node 750 in the output layer 706. While each node in each layer in this example is fully connected to the nodes in the adjacent layer(s) for illustrative purpose only, it has been contemplated that the nodes in different layers can be connected according to any other neural network topologies as needed for the purpose of performing a corresponding task.

The hidden layer 704 is an intermediate layer between the input layer 702 and the output layer 706 of the artificial neural network 700. Although only one hidden layer is shown for the artificial neural network 700 for illustrative purpose only, it has been contemplated that the artificial neural network 700 used to implement any one of the computer-based models may include as many hidden layers as necessary. The hidden layer 704 is configured to extract and transform the input data received from the input layer 702 through a series of weighted computations and activation functions.

In this example, the artificial neural network 700 receives a set of inputs and produces an output. Each node in the input layer 702 may correspond to a distinct input. For example, when the artificial neural network 700 is used to implement an AI agent, the nodes in the input layer 702 may correspond to different parameters and/or attributes of a prompt.

In some embodiments, each of the nodes 744, 746, and 748 in the hidden layer 704 generates a representation, which may include a mathematical computation (or algorithm) that produces a value based on the input values received from the nodes 732, 734, 736, 738, 740, and 742. The mathematical computation may include assigning different weights (e.g., node weights, edge weights, etc.) to each of the data values received from the nodes 732, 734, 736, 738, 740, and 742, performing a weighted sum of the inputs according to the weights assigned to each connection (e.g., each edge), and then applying an activation function associated with the respective node (or neuron) to the result. The nodes 744, 746, and 748 may include different algorithms (e.g., different activation functions) and/or different weights assigned to the data variables from the nodes 732, 734, 736, 738, 740, and 742 such that each of the nodes 744, 746, and 748 may produce a different value based on the same input values received from the nodes 732, 734, 736, 738, 740, and 742. The activation function may be the same or different across different layers. Example activation functions include but not limited to Sigmoid, hyperbolic tangent, Rectified Linear Unit (ReLU), Leaky ReLU, Softmax, and/or the like. In this way, after a number of hidden layers, input data received at the input layer 702 is transformed into rather different values indicative data characteristics corresponding to a task that the artificial neural network 700 has been designed to perform.

In some embodiments, the weights that are initially assigned to the input values for each of the nodes 744, 746, and 748 may be randomly generated (e.g., using a computer randomizer). The values generated by the nodes 744, 746, and 748 may be used by the node 750 in the output layer 706 to produce an output value (e.g., a response to a user query, a prediction, etc.) for the artificial neural network 700. The number of nodes in the output layer depends on the nature of the task being addressed. For example, in a binary classification problem, the output layer may consist of a single node representing the probability of belonging to one class. In a multi-class classification problem, the output layer may have multiple nodes, each representing the probability of belonging to a specific class. When the artificial neural network 700 is used to implement an AI agent, the output node 750 may be configured to generate new content (e.g., a response in a natural language format, instructions for other AI agents, programming code, a software application package, etc.) based on the prompt.

In some embodiments, the artificial neural network 700 may be implemented on one or more hardware processors, such as CPUs (central processing units), GPUs (graphics processing units), FPGAs (field-programmable gate arrays), Application-Specific Integrated Circuits (ASICs), dedicated AI accelerators like TPUs (tensor processing units), and specialized hardware accelerators designed specifically for the neural network computations described herein, and/or the like. Example specific hardware for neural network structures may include, but not limited to Google Edge TPU, Deep Learning Accelerator (DLA), NVIDIA AI-focused GPUs, and/or the like. The hardware used to implement the neural network structure is specifically configured based on factors such as the complexity of the neural network, the scale of the tasks (e.g., training time, input data scale, size of training dataset, etc.), and the desired performance.

The artificial neural network 700 may be trained by using training data based on one or more loss functions and one or more hyperparameters. By using the training data to iteratively train the artificial neural network 700 through a feedback mechanism (e.g., comparing an output from the artificial neural network 700 against an expected output, which is also known as the “ground-truth” or “label”), the parameters (e.g., the weights, bias parameters, coefficients in the activation functions, etc.) of the artificial neural network 700 may be adjusted to achieve an objective according to the one or more loss functions and based on the one or more hyperparameters such that an optimal output is produced in the output layer 706 to minimize the loss in the loss functions. Given the loss, the negative gradient of the loss function is computed with respect to each weight of each layer individually. Such negative gradient is computed one layer at a time, iteratively backward from the last layer (e.g., the output layer 706 to the input layer 702 of the artificial neural network 700). These gradients quantify the sensitivity of the network's output to changes in the parameters. The chain rule of calculus is applied to efficiently calculate these gradients by propagating the gradients backward from the output layer 706 to the input layer 702.

Parameters of the artificial neural network 700 are updated backwardly from the last layer to the input layer (backpropagating) based on the computed negative gradient using an optimization algorithm to minimize the loss. The backpropagation from the last layer (e.g., the output layer 706) to the input layer 702 may be conducted for a number of training samples in a number of iterative training epochs. In this way, parameters of the artificial neural network 700 may be gradually updated in a direction to result in a lesser or minimized loss, indicating the artificial neural network 700 has been trained to generate a predicted output value closer to the target output value with improved prediction accuracy. Training may continue until a stopping criterion is met, such as reaching a maximum number of epochs or achieving satisfactory performance on the validation data. At this point, the trained network can be used to make predictions on new, unseen data, such as to predict a frequency of future related transactions.

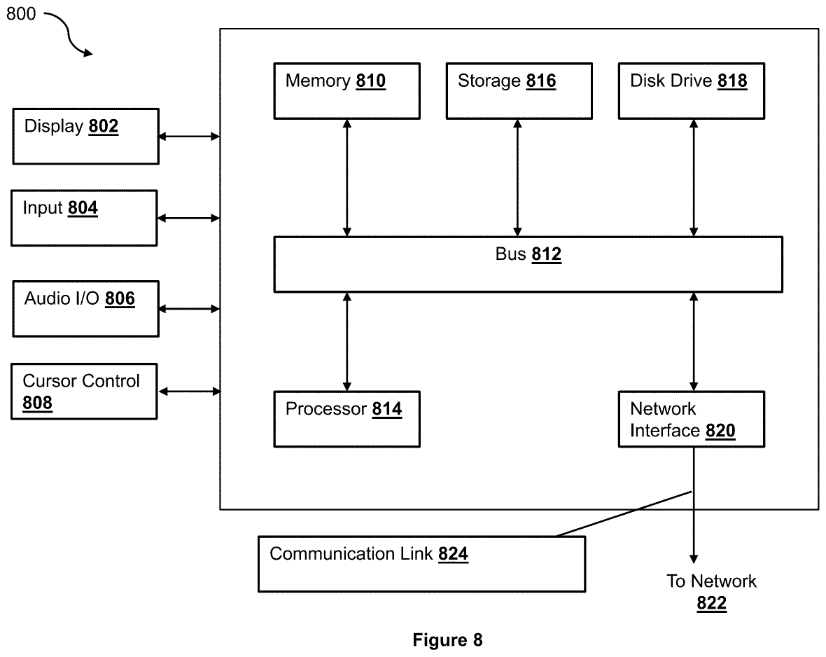

FIG. 8 is a block diagram of a computer system 800 suitable for implementing one or more embodiments of the present disclosure, including the service provider server 130, the merchant server 120, the user device 180, and the user device 110. In various implementations, each of the user devices 110 and 180 may include a mobile cellular phone, personal computer (PC), laptop, wearable computing device, etc. adapted for wireless communication, and each of the service provider server 130 and the merchant server 120 may include a network computing device, such as a server. Thus, it should be appreciated that the devices 110, 120, 130, and 180 may be implemented as the computer system 800 in a manner as follows.

The computer system 800 includes a bus 812 or other communication mechanism for communicating information data, signals, and information between various components of the computer system 800. The components include an input/output (I/O) component 804 that processes a user (i.e., sender, recipient, service provider) action, such as selecting keys from a keypad/keyboard, selecting one or more buttons or links, etc., and sends a corresponding signal to the bus 812. The I/O component 804 may also include an output component, such as a display 802 and a cursor control 1108 (such as a keyboard, keypad, mouse, etc.). The display 802 may be configured to present a login page for logging into a user account or a checkout page for purchasing an item from a merchant. An optional audio input/output component 806 may also be included to allow a user to use voice for inputting information by converting audio signals. The audio I/O component 806 may allow the user to hear audio. A transceiver or network interface 820 transmits and receives signals between the computer system 800 and other devices, such as another user device, a merchant server, or a service provider server via a network 822. In one embodiment, the transmission is wireless, although other transmission mediums and methods may also be suitable. A processor 814, which can be a micro-controller, digital signal processor (DSP), or other processing component, processes these various signals, such as for display on the computer system 800 or transmission to other devices via a communication link 824. The processor 814 may also control transmission of information, such as cookies or IP addresses, to other devices.

The components of the computer system 800 also include a system memory component 810 (e.g., RAM), a static storage component 816 (e.g., ROM), and/or a disk drive 818 (e.g., a solid-state drive, a hard drive). The computer system 800 performs specific operations by the processor 814 and other components by executing one or more sequences of instructions contained in the system memory component 810. For example, the processor 814 can perform the conversation assistance functionalities described herein, for example, according to the processes 500 and 600.

Logic may be encoded in a computer readable medium, which may refer to any medium that participates in providing instructions to the processor 814 for execution. Such a medium may take many forms, including but not limited to, non-volatile media, volatile media, and transmission media. In various implementations, non-volatile media includes optical or magnetic disks, volatile media includes dynamic memory, such as the system memory component 810, and transmission media includes coaxial cables, copper wire, and fiber optics, including wires that comprise the bus 812. In one embodiment, the logic is encoded in non-transitory computer readable medium. In one example, transmission media may take the form of acoustic or light waves, such as those generated during radio wave, optical, and infrared data communications.

Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by the computer system 800. In various other embodiments of the present disclosure, a plurality of computer systems 800 coupled by the communication link 824 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The various features and steps described herein may be implemented as systems comprising one or more memories storing various information described herein and one or more processors coupled to the one or more memories and a network, wherein the one or more processors are operable to perform steps as described herein, as non-transitory machine-readable medium comprising a plurality of machine-readable instructions which, when executed by one or more processors, are adapted to cause the one or more processors to perform a method comprising steps described herein, and methods performed by one or more devices, such as a hardware processor, user device, server, and other devices described herein.

What is claimed is:

1. A system comprising:
a non-transitory memory; and
one or more hardware processors coupled with the non-transitory memory and configured to execute instructions from the non-transitory memory to cause the system to:
receive, from a device, a prompt associated with a particular domain;
determine, using a large language model, a plurality of attributes associated with the prompt based on an understanding of semantics associated with the prompt;
retrieve a cluster of nodes from a graph based on the plurality of attributes associated with the prompt, wherein the graph comprises a plurality of nodes representing a plurality of documents related to the particular domain, wherein two nodes in the graph are connected when two documents represented by the two nodes have one or more common attributes, and wherein the plurality of nodes are divided into a plurality of clusters of nodes based on connection densities of different portions of the graph;
generate, using one or more artificial intelligence (AI) agents, a response to the prompt based on content included in a subset of the plurality of documents represented by the cluster of nodes; and
provide the response to the user device.

2. The system of claim 1, wherein the plurality of attributes associated with the prompt comprises a task attribute, a topic attribute, and a subject attribute.

3. The system of claim 1, wherein the cluster of nodes share one or more common attributes, and wherein the one or more common attributes overlap with at least one of the plurality of attributes associated with the prompt.

4. The system of claim 1, wherein each AI agent in the one or more AI agents has a corresponding specialty, and wherein executing the instructions further causes the system to:
identify a plurality of tasks based on the prompt received from the user device; and
assign each task in the plurality of tasks to a corresponding AI agent in the one or more agents based on a match between the task and the corresponding specialty of the corresponding AI agent.

5. The system of claim 4, wherein executing the instructions further causes the system to:
obtain corresponding outputs from the one or more AI agents, wherein the response is generated further based on the corresponding outputs.

6. The system of claim 1, wherein the particular domain is associated with software development, and wherein the response comprises programming code associated with a software application.

7. The system of claim 1, wherein the one or more AI agents are configured to (i) generate programming code associated with a software application based on the prompt, (ii) test the software application according to a plurality of use cases, and (iii) correct errors in the programming code based on a result from testing the software application.

8. A method, comprising:
receiving, by a computer system, a prompt intended for an artificial intelligence (AI) agent;
determining, by the computer system, a plurality of attributes associated with the prompt based on analyzing the prompt;
identifying, by the computer system, a cluster of nodes from a graph based on the plurality of attributes associated with the prompt, wherein the graph comprises a plurality of nodes representing a plurality of documents stored in a document repository, wherein two nodes in the graph are connected when two documents represented by the two nodes have one or more common attributes;
retrieving, by the computer system, one or more documents represented by one or more nodes from the cluster of nodes; and
generating, using the AI agent, a response to the prompt based on content included in the one or more documents.

9. The method of claim 8, further comprising:
selecting, from the cluster of nodes, one or more nodes that match with the prompt based on attributes associated with the cluster of nodes and the plurality of attributes associated with the prompt, wherein the one or more documents are represented by the one or more nodes.

10. The method of claim 9, wherein the cluster of nodes share one or more common attributes, and wherein the one or more common attributes overlap with at least one of the plurality of attributes associated with the prompt.

11. The method of claim 8, wherein the prompt is received from a user device, and wherein the method further comprises transmitting the response to the user device.

12. The method of claim 8, further comprising:
receiving a request to add a document to the document repository, wherein the document comprises software programming code;
generating, for the document, a second plurality of attributes based on analyzing one or more functionalities associated with the software programming code; and
inserting a node representing the document into the graph based on the second plurality of attributes.

13. The method of claim 12, further comprising:
generating, using a second AI agent, commentaries to the software programming code that describe the one or more functionalities associated with the software programming code, wherein the second plurality of attributes is generated based on the commentaries.

14. The method of claim 12, wherein the second plurality of attributes represents one or more queries for which the document is usable for generating an answer.

15. A non-transitory machine-readable medium having stored thereon machine-readable instructions executable to cause a machine to perform operations comprising:
receiving a prompt intended for an artificial intelligence (AI) agent;
determining a plurality of attributes associated with the prompt;
determining, from a graph comprising a plurality of nodes representing a plurality of documents stored in a document repository, a cluster of nodes based on the plurality of attributes associated with the prompt matching attributes associated with the cluster of nodes;
selecting, from a set of documents represented by the cluster of nodes, one or more documents that are relevant to the prompt using an index associated with the set of documents; and
generating, using the AI agent, a response to the prompt based on content included in the one or more documents.

16. The non-transitory machine-readable medium of claim 15, wherein two nodes in the graph are connected when two documents represented by the two nodes have one or more common attributes, and wherein the plurality of nodes are divided into a plurality of clusters of nodes based on connection densities of different portions of the graph.

17. The non-transitory machine-readable medium of claim 15, wherein the prompt is received from a user device, and wherein the operations further comprise transmitting the response to the user device.

18. The non-transitory machine-readable medium of claim 17, wherein the operations further comprise:
receiving a request to add a document to the document repository, wherein the document comprises software programming code;
generating, for the document, a second plurality of attributes based on analyzing one or more functionalities associated with the software programming code; and
inserting a node representing the document into the graph based on the second plurality of attributes.

19. The non-transitory machine-readable medium of claim 18, wherein the operations further comprise:
generating, using a second AI agent, commentaries to the software programming code that describe the one or more functionalities associated with the software programming code, wherein the second plurality of attributes is generated based on the commentaries.

20. The non-transitory machine-readable medium of claim 18, wherein the second plurality of attributes represents one or more queries for which the document is usable for generating an answer.
